(19) United States
(12) Patent Application Publication
(10) Pub. No.: US 2010/0306052 A1
(43) Pub. Date: Dec. 2, 2010

(54) METHOD AND APPARATUS FOR MODIFYING INTERNET CONTENT THROUGH REDIRECTION OF EMBEDDED OBJECTS

(76) Inventors: Zachary Edward Britton, Tuolumne, CA (US); Derek Stephen Maxson, Twain Harte, CA (US); Brian Mathew Blocher, Oakdale, CA (US); Thabo Husayn Fletcher, Sonora, CA (US); Scott Kenneth Smith, Modesto, CA (US); Carlos Alberto Vazquez, Chula Vista, CA (US); Cameron D. Jordan, Sonora, CA (US); Christopher F. Smith, Sonora, CA (US); Zachariah James Wise, Jamestown, CA (US)

Correspondence Address: ROBROY R FAWCETT, 1576 KATELLA WAY, ESCONDIDO, CA, 92027, US

(21) Appl. No.: 12/546,612

(22) Filed: Aug. 24, 2009

Related U.S. Application Data
(63) Continuation of application No. 61/182,118, filed on May 29, 2009.

(51) Int. Cl. G06Q 30/00; G06F 15/16

(52) U.S. Cl. 705/14.53; 709/219

(57) ABSTRACT

Disclosed is a method, and related apparatus, for directing network service provider selected embedded objects to an internet user client. In the method, a network service provider maintains a database of internet user clients that includes a particular service-type value for each internet user client. The network service provider analyzes an HTTP transaction involving the internet user client. The network service provider responds to an HTTP transaction requesting an embedded web object by forwarding to the internet user client, an alternative embedded web object selected in accordance with the user client's particular service-type value, wherein the alternative embedded web object arrives to the internet user client before a response to the originally requested embedded web object. The network service provider causes the originally requested embedded web object to be forwarded to the internet user client after the alternative embedded web object is forwarded to the internet user client.

### CROSS-REFERENCE TO RELATED APPLICATIONS

This application claims the benefit of U.S. Provisional Application No. 61/182,118, filed May 29, 2009, which application is incorporated herein by reference.

### BACKGROUND OF THE INVENTION

1. Field of the Invention

The present invention relates to the delivery and customization of Internet content to deliver specific communications to Internet users by their Internet Service Provider.

2. Description of the Prior Art and Related Information

Internet Service Providers (ISPs) provide many valuable services for consumers beyond transmitting packets of digital information. ISPs provide security, quality-of-service, privacy services, Internet filtering and other value-added services to their consumers.

Since the earliest days of the broad commercialization of the Internet in the mid 1990's, ISPs have primarily provided access to content provided by Internet Content Providers (ICPs) such as YAHOO and MICROSOFT. While providing the basic access to the web servers of ICPs, consumers expect uninterrupted service. When there is an interruption in the service, a condition of account delinquency between the ISP and its user, or the need for the ISP to receive acknowledgement of a piece of legal compliance notice, the cost and complexities of customer communication is high.

ISPs typically use postal mail, email and telephone to communicate with their subscribers. However each of these methods lack one or more of these benefits: inexpensive, fast delivery, and guarantee of delivery. Postal mail is expensive and, with the increase of paperless billing, is being used less by ISPs. Email is quite effective for those subscribers who utilize the ISP-provided email account or provide an alternate address to the ISP. However, the ISP may not know the primary email address of their subscribers due to the popularity and use of web-based email services provided by GOOGLE and YAHOO. Telephone service is more expensive than all the other methods and is not a cost-effective solution for the ISP.

ISPs may wish to communicate effectively with their subscribers for many reasons including: delinquent payments, violation of terms of use such as exceeding limits of time or volumes of transmission, violation of copyrights of digital media, or to promote products and services through advertisements. As these examples show, there is a wide variety of content types an ISP may want to deliver to their subscribers.

Various existing methods for the customization of Internet content to end users such as Britton, (U.S. Pat. No. 6,442,577) and Slemmer (U.S. Pat. No. 6,226,677) provide models for the customization. These patents represent the current models of Internet customization for delivering communication from the ISP to the subscriber. In these models, HTML content, such as web page files for use as full pages or elements within pages such as frames, iframes or windows, is modified or replaced by content customized for the subscriber. This has proven to be an effective model of communication in the past, but new methods are desired for the delivery of advanced models of communication described in the present invention.

The Slemmer patent provides the ISP with the capability of sending various sorts of Internet communication to the user by using page redirection from the original web page requested by a user to a replacement page which may be populated with whatever content that the ISP should choose to display. However, the methods of communication as detailed in the Slemmer patent have the potential to cause the disruption or delay of the requested Internet content. The Slemmer patent is based upon the use of a proxy which has since been proven in the industry to be insufficient in facilitating the increasing load of Internet traffic today.

The Britton patent provides the capability to an ISP to customize web pages to their users according to criteria located in the service request.

In addition, networking equipment provided by companies such as CISCO, JUNIPER and F5 NETWORKS perform content customization by the replacement or modification of web pages. With the proliferation of Internet browsers employed by users such as INTERNET EXPLORER, FIREFOX, SAFARI and CHROME, and the billions of web pages available today, there are an increasing number of conflicts between customization methodologies and the vast array of styles and methods of web page design.

Delivery of customized Internet communication requires a flexible format that does not obstruct the user's access to the Internet content requested. Prior methods have included modification of the original web page. In this model, during serving or transmission, the contents of a web page are modified through addition, deletion or modification of pre-existing content so as to customize the content for a user or group of users.

Additionally, modifying the HTML page can result in unintended consequences such as failure of the page to load correctly or excessive delay in loading the page. It is a requirement of services which insert messages to be able to guarantee transparency to the end user.

There is, therefore, a need for a method and apparatus which enables ISPs to more effectively communicate with their subscribers. The present invention provides the methods and apparatuses to meet these needs.

### SUMMARY OF THE INVENTION

The present invention may be embodied in an Internet traffic monitoring method that includes an ISP analyzing an HTTP transaction containing an embedded web object such as JavaScript or Flash or other similar object involving an Internet user client. The ISP responds to the HTTP transaction by forwarding, to the Internet user client, a modified web object including a reference to the original embedded object plus a reference to an additional embedded object.

In more detailed features of the invention, the HTTP transaction for an embedded object may include customized content for the subscriber that may be targeted according to the ISP's communication requirements. The ISP may create business rules for the notification of subscribers who meet specific criteria for communication.

In one embodiment of the present invention, the user may be delivered a specific communication when the registered payment credit card is nearing expiration, or the user's bill has become past due.

In yet another embodiment, if a subscriber has violated the terms of use or a law regulating Internet use, the present invention may be used to deliver a specific communication.

In another embodiment, the ISP or its partners may deliver a specific communication offering products or services to the subscriber.

In other more detailed features of this invention, the type of content to display may comprise redirections, frame insertions, interstitials, page modifications and other methods as allowed by W3C specifications and the extensive capabilities of web browsers.

In other more detailed features of the invention, an advertisement selection service may select targeted advertising web content for presentation by the Internet user client based on at least one targeting parameter from the ISP or a 3^{rd} party partner of the ISP.

Additionally, the present invention may be embodied in a method for directing network service provider selected embedded objects to an internet user client. In the method, a network service provider maintains a database of internet user clients that includes a particular service-type value for each internet user client. The network service provider analyzes an HTTP transaction involving the internet user client. The network service provider responds to an HTTP transaction requesting an embedded web object by forwarding to the internet user client, an alternative embedded web object selected in accordance with the user client's particular service-type value, wherein the alternative embedded web object arrives to the internet user client before a response to the originally requested embedded web object. The network service provider causes the originally requested embedded web object to be forwarded to the internet user client after the alternative embedded web object is forwarded to the internet user client.

In more detailed features of the invention, the network service provider may be an internet service provider, and the internet user client may be a subscribing user client. The alternative embedded web object may include a request for the originally requested embedded web object. The originally requested embedded web object may be a javascript object, and the alternative embedded web object may be a javascript object that includes a request for a javascript object of the originally requested embedded web object. The alternative embedded web object may be selected by the network service provider. The alternative embedded web object may comprise a reference to the originally requested embedded web object, and a reference to an additional embedded web object. The reference to an additional embedded web object may be associated with targeted advertising web content. The targeted advertising web content may be selected by an advertisement selection service. The advertisement selection service may select the targeted advertising web content based on at least one targeting parameter received from the network service provider. The advertisement selection service may select the targeted advertising web content based on a modification value rank. The reference to an additional embedded web object may be selected in accordance with a URL inclusion field and/or with a URL restriction field. Also, more than one internet user client may be associated with a particular service-type value.

In other more detailed features of the invention, customized content associated with the additional embedded web object may be presented in a first frame, and unmodified content associated with the originally requested embedded web object may be presented in a second frame. Alternatively, a link to customized content associated with the additional embedded web object may be presented in the first frame. The customized content may be presented in a new window displayed over a window presenting the unmodified content. The customized content may be presented in a new window under a window presenting the unmodified content associated with the originally requested embedded web object. The customized content may be presented in a content region that flies over the unmodified content. The customized content may be presented in a semi-transparent content region over the unmodified content. The semi-transparent content region may fade into a fully opaque content region.

The present invention also may be embodied in an apparatus for directing network service provider selected embedded objects to an internet user client. The apparatus may include means for maintaining a database of internet user clients that includes a particular service-type value for each the internet user client, means for analyzing an HTTP transaction involving the internet user client, means for responding to an HTTP transaction requesting an embedded object by forwarding to the internet user client, an alternative embedded web object selected by a network service provider, wherein the alternative embedded web object arrives to the internet user client before a response to the originally requested web object, and means for causing the originally requested web object to be forwarded to the internet user client after the alternative embedded web object is forwarded to the internet user client.

Further, the present invention may be embodied in a computer program product comprising computer readable medium storing: code for causing a computer to maintain a database of a network service provider's internet user clients that includes a particular service-type value for each the internet user client, code for causing a computer to analyze an HTTP transaction involving the internet user client, code for causing a computer to respond to an HTTP transaction requesting an embedded object by forwarding to the internet user client, an alternative embedded web object selected by a network service provider, wherein the alternative embedded web object arrives to the internet user client before a response to the originally requested web object, and code for causing a computer to forward the originally requested web object to the internet user client after the alternative embedded web object is forwarded to the internet user client.

### BRIEF DESCRIPTION OF THE DRAWINGS

The aforementioned advantages of the present invention as well as additional advantages thereof will be more clearly understood hereinafter as a result of a detailed description of a preferred embodiment of the invention when taken in conjunction with the following drawings in which:

FIG. 1 depicts an exemplary network system, in which the present invention can function.

FIG. 2 depicts an exemplary HTTP transaction, in which content modification has been performed according to the present invention.

FIG. 3 depicts an exemplary HTTP transaction without modifications.

FIG. 4 depicts an exemplary HTTP transaction with modifications according to the present invention.

FIG. 5 depicts a flowchart illustrating the process of detecting a user session and assigning a service plan, in accordance with the present invention.

FIG. 6 depicts a flowchart illustrating the process of analyzing an HTTP transaction and applying eligible content modification, in accordance with the present invention.

FIG. 7 depicts a flowchart illustrating the process of modifying an HTTP transaction, in accordance with the present invention.

FIG. 8 depicts an exemplary subscriber service database for the present invention.

FIG. 9 depicts an exemplary active session database for the present invention.

FIG. 10 depicts an exemplary service subscription database for the present invention.

FIG. 11 depicts an exemplary URL list database for the present invention.

FIG. 12 depicts an exemplary content modification database for the present invention.

FIG. 13 depicts an exemplary web page with top framed content modification in place.

FIG. 14 depicts an exemplary web page with bottom framed content modification in place.

FIG. 15 depicts an exemplary web page with left framed content modification in place.

FIG. 16 depicts an exemplary web page with right framed content modification in place.

FIG. 17 depicts an exemplary web page with content modification in the form of a pop-up.

FIG. 18 depicts an exemplary web page with content modification in the form of a pop-under.

FIG. 19 depicts an exemplary web page with content modification in the form of a flyover message.

FIG. 20 depicts an exemplary web page with content modification in the form of an intertoastal message.

FIG. 21 depicts an exemplary web page before and after a content modification has taken place.

FIG. 22 depicts an exemplary web page with content modification in the form of a peel-over message

FIG. 23 depicts an exemplary web page with content modification in the form of an interstitial message.

FIG. 24 depicts an exemplary web page with content modification in the form of a redirect message.

### DETAILED DESCRIPTION

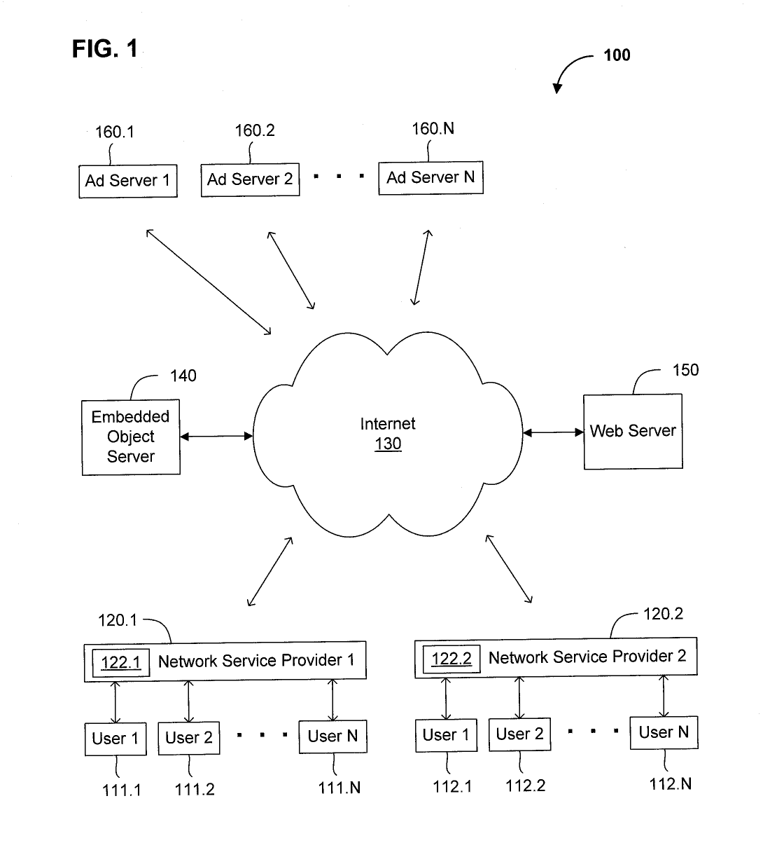

FIG. 1 depicts a diagram illustrating an exemplary network 100, which includes one or more Internet users connected to the Internet via ISPs. The web site traffic of these users is monitored by one or more advertising networks and one or more traffic measurement companies via the present invention.

As shown in FIG. 1, the network 100 includes users 111.1-112.N, one or more ISPs 120.1-120.2, the Internet 130, an embedded object server 140, a web server 150, and one or more advertising networks 160.1-160.N.

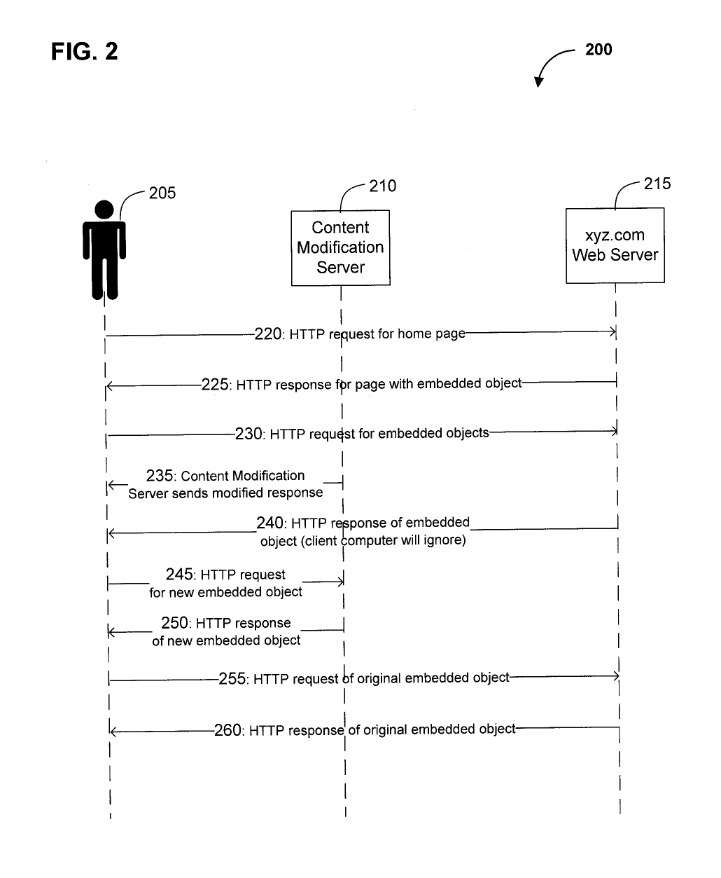

FIG. 2 depicts a diagram illustrating an exemplary HTTP transaction 200 which is initiated by a client which is modified by a content modification server 210 in accordance with the present invention.

At step 220, the client makes an HTTP request for a page on a web server 215.

At step 225, the web server 215 sends an HTTP response for a page with an embedded web object to the client.

At step 230, the client makes an HTTP request for the embedded objects on the web server 215.

At step 235, the content modification server 210 sends a modified HTTP response to the client.

At step 240, the web server 215 sends an HTTP response with the embedded web object to the client 205. The client will ignore this response because it has already received a modified HTTP response from the content modification server 210.

At step 245, the client makes an HTTP request for a new embedded object as directed by the content modification server 210 in step 235.

At step 250, the content modification server 210 sends the HTTP response for the new embedded object to the client.

At step 255, the client makes an HTTP request for the original embedded object to the web server 215. The requested embedded web object is the same one that the client ignored in step 240.

At step 260, the web server 215 sends an HTTP response for the original embedded object to the client.

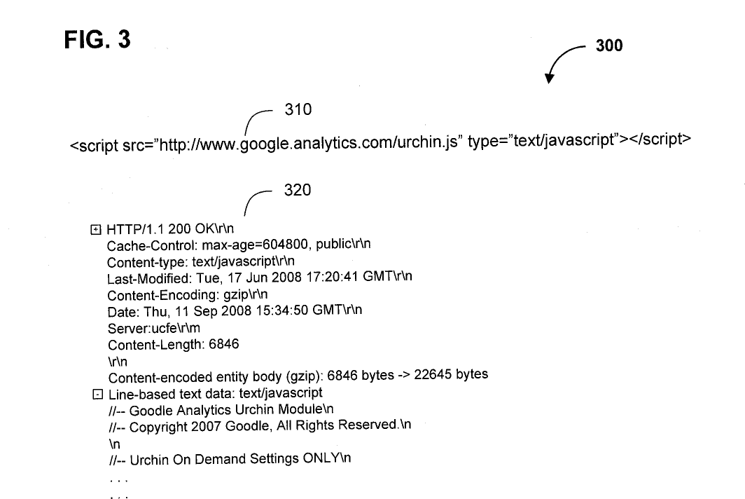

FIG. 3 depicts an exemplary HTTP transaction without modifications 300 wherein a web browser executed the HTML for making a request to a web server for a JavaScript object 310 as in step 220 of FIG. 2. The web server returns an HTTP response containing JavaScript code 320 in order to execute the desired operation for the web object as in step 225 of FIG. 2.

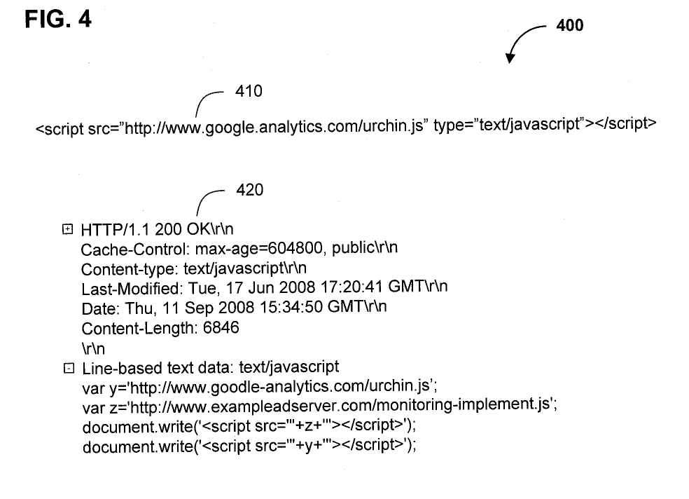

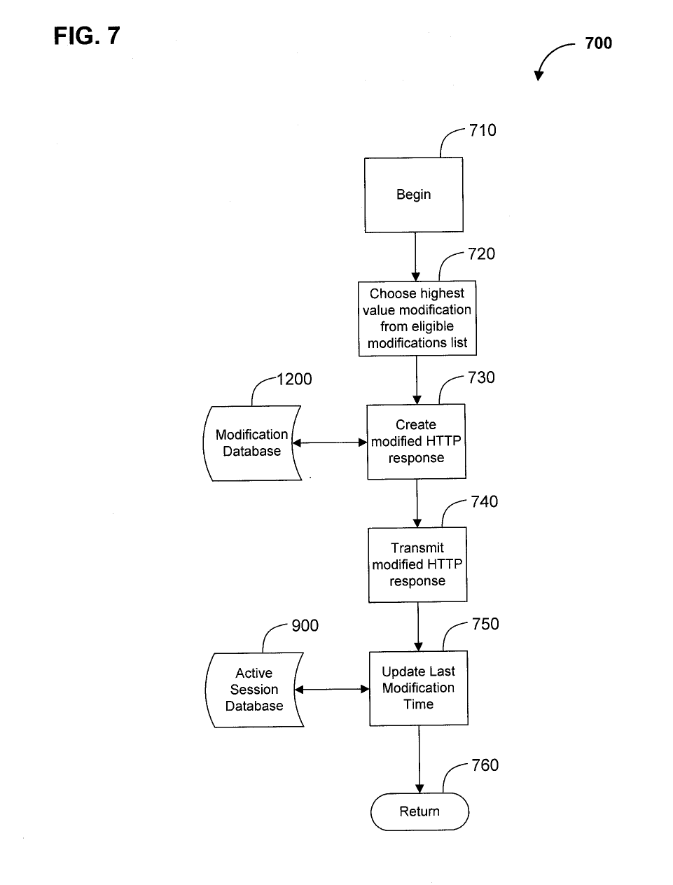

FIG. 4 depicts an exemplary HTTP transaction with modifications according to the present invention 400 for inserting modifying web content by modifying the embedded object's response as in step 235 of FIG. 2 and process 700, as shown in FIG. 7. A web request 410 is sent to the web server. The response from the web server is modified or replaced with a new response 420 which contains JavaScript code to execute a desired operation for a new web object as well as a request for the original web object as in steps 245 and 255 of FIG. 2.

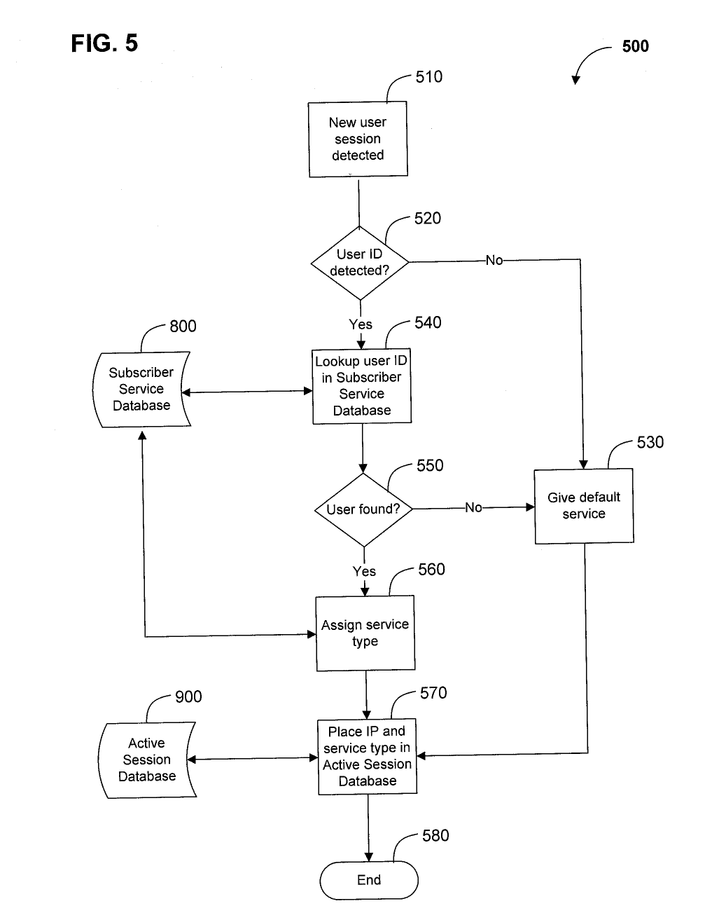

FIG. 5 depicts a flowchart illustrating the process 500 of detecting a user session and assigning a service plan, in accordance with the present invention. In describing FIG. 5, it is assumed that: 1) The Internet user is connected to the Internet through an ISP (as shown in FIG. 1) that utilizes the invention; and 2) requests web content from various web servers which contain references to embedded content (as shown in FIG. 1, 160.1-171).

In FIG. 5, the Internet user (which can be any one of the users shown in FIGS. 1, 111.1-112.N) first establishes an Internet connection through an ISP (as shown in FIGS. 1, 120.1 and 120.2). At step 510 the present invention detects a new user session from an Internet user (which can be using any one of the users 111.1-112.N).

At step 520, if a user ID is detected for the new user session, the user is sent to step 540 otherwise program flow is transferred to step 530.

At step 530, the application applies the default service type to the user and sends the user to step 570.

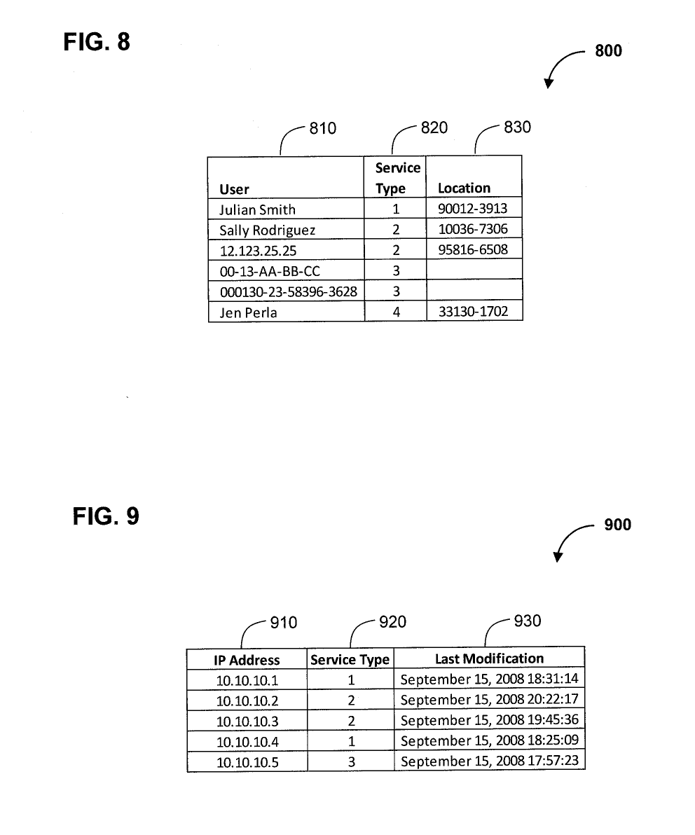

At step 540, the application checks field 810 in the database 800, shown in FIG. 8, to see if the user ID contains subscriber service settings.

At step 550, if the database does not contain references to the user ID referenced in step 540, then the user is sent to step 530. If the database does contain subscriber service settings, those settings are applied and the program proceeds to step 560.

At step 560, the application assigns the service type as directed for the user ID in field 820 in the database 800. The program flow proceeds to step 570.

At step 570, the application places the user's IP address and service settings in fields 910 and 920 respectively of the active session database 900. When the user information has been placed in the database 900, the program flow proceeds to step 580.

At step 580 the process terminates.

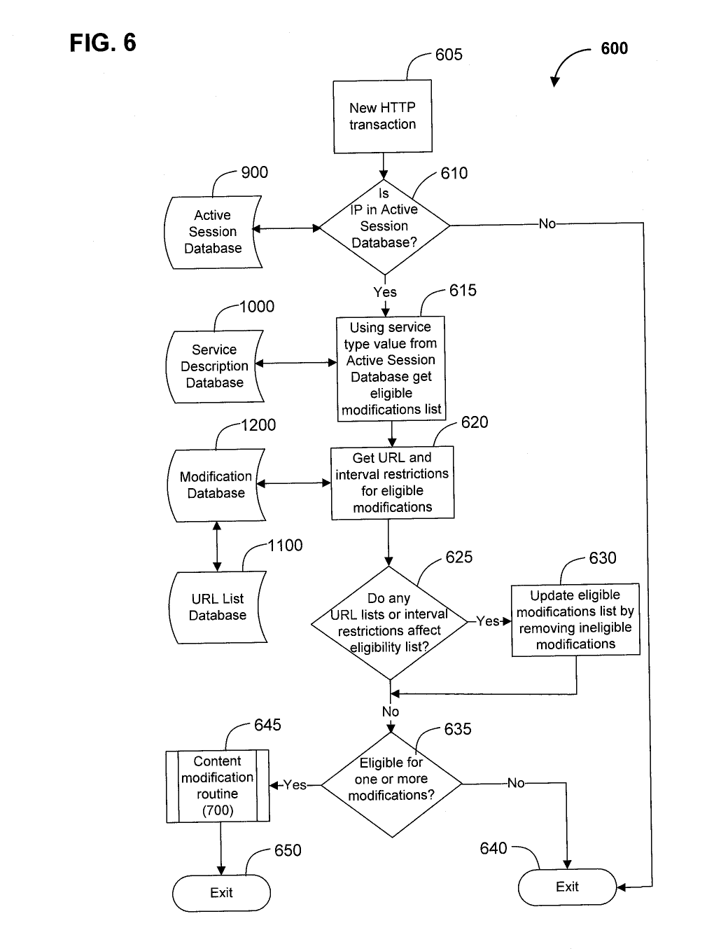

FIG. 6 depicts a flowchart illustrating the process 600 of analyzing an HTTP transaction and applying eligible content modification, in accordance with the present invention. In describing FIG. 6, it is assumed that: 1) The Internet user is connected to the Internet through an ISP (as shown in FIG. 1) that utilizes the invention; and 2) requests web content from various web servers which contain references to embedded content (as shown in FIG. 1, 160.1-171).

At step 605, the Internet user (which can be using any one of the users 111.1-112.N) initiates a new HTTP transaction by requesting web content as in step 220 of FIG. 2.

At step 610, the application correlates the source IP address in the HTTP request with the field 910 to see if the user's IP is in the active session database 900. If the user is not in an active session, the program flow proceeds to step 640. If the user is in an active session, the program flow proceeds to step 615.

At step 615, the application uses the service type from field 920 in the active session database 900 to retrieve eligible modifications from fields 1020.1-1020.N which apply for the selected service type in field 1010 of the service subscription database 1000. The program flow proceeds to step 620.

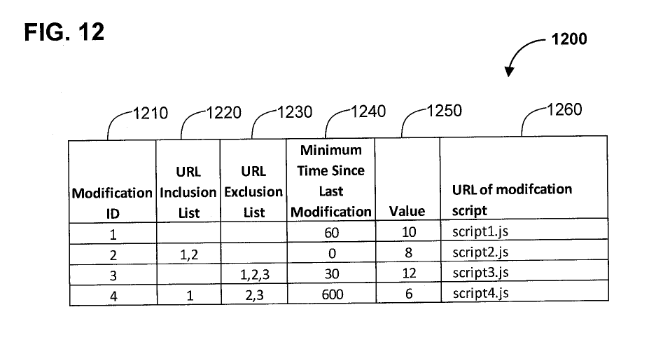

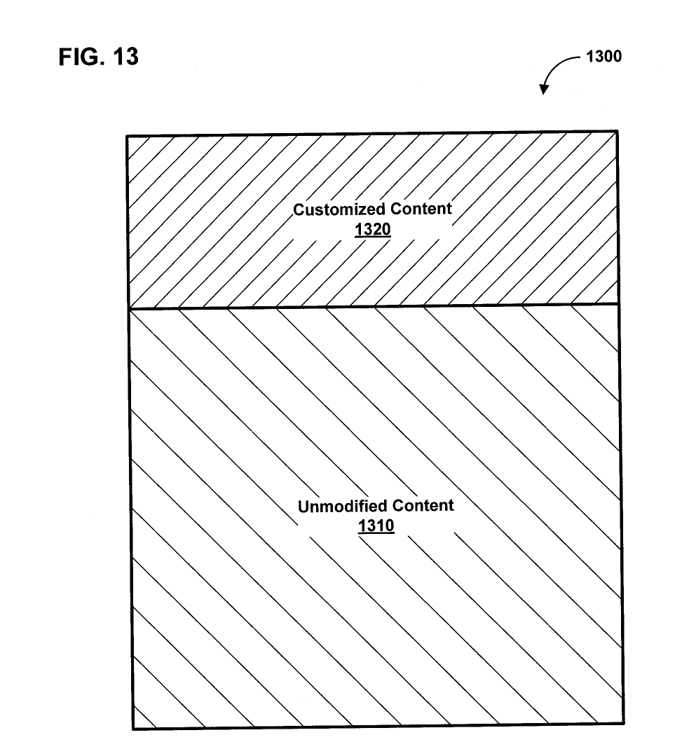

At step 620, application gets interval restrictions from field 1240 in the modification database 1200 for each of the eligible modification IDs in field 1210 of database 1200. URL inclusions and restrictions from fields 1220 and 1230 in database 1200, shown in FIG. 12, are retrieved from database 1100.

At step 625, if the elapsed time between relevant intervals and the time of last modification in field 930 of the active session database 900 does not permit the modification to be performed, or any of the URL restrictions apply, the program flow proceeds to step 630. Otherwise, the program flow proceeds to step 635.

At step 630, the eligible modifications list is updated to remove ineligible modifications. The program flow proceeds to step 635.

At step 635, if the user is eligible for one or more modification, the program flow proceeds to step 645. If the user is not eligible for any modification, the program flow proceeds to step 640.

At step 640, the process terminates.

At step 645, the application conducts the content modification routine 700, shown in FIG. 7, and the program flow proceeds to step 650.

At step 650, the process terminates.

FIG. 7 depicts a flowchart illustrating the process 700 of modifying an HTTP transaction, in accordance with the present invention.

At step 710, the content modification process is initiated through by step 645 as shown in FIG. 6.

At step 720, the application chooses the highest value modification in field 1250 of the modification database 1200, shown in FIG. 12, from the eligible modifications list passed from process 600. The program flow proceeds to step 730.

At step 730, the application creates a modified HTTP response from field 1260 of the modification database 1200.

At step 740, the modified HTTP response is sent to the user as in step 235 of FIG. 2.

At step 750, the application updates the last modification time in field 930 of the active session database 900, shown in FIG. 9, with the most recent modification timestamp.

At step 760, the process returns to step 645 in the process 600 of FIG. 6.

FIG. 8 depicts an exemplary subscriber service database 800 located at a ISP (or, alternatively, it can be located off-site on a separate network) (which can be any one of the

ISPs 120.1-120.2) for storing user identification and service type information, in accordance with the present invention.

The subscriber service database 800 (which runs on a computer system as shown in FIG. 1 has at least three fields: 1) a Subscriber or User field, 810, containing the username (some NSPs could use this field for the user's IP address, Media Access Control—MAC address, or Global Unique Identifier—GUID, instead of a username); 2) a Service Type field, 820, detailing which service type the user is subscribed to; and 3) a Location field, 830 containing the subscriber's location.

FIG. 9 depicts an exemplary active session database 900 located at a ISP (or, alternatively, it can be located off-site on a separate network) (which can be any one of the ISPs 120.1-120.2) for storing active session and last modification time information, in accordance with the present invention.

The active session database 900 (which runs on a computer system as shown in FIG. 1 has at least three fields: 1) an IP address field, 910, containing the user's currently assigned IP address; 2) a Service Type field, 920, detailing which service type the user is subscribed to; and 3) a Last Modification field, 930 containing a timestamp of the last time a content modification was conducted for the user. In other embodiments multiple timestamps may be employed and the user may be characterized by multiple service types to allow more granular control over modifications.

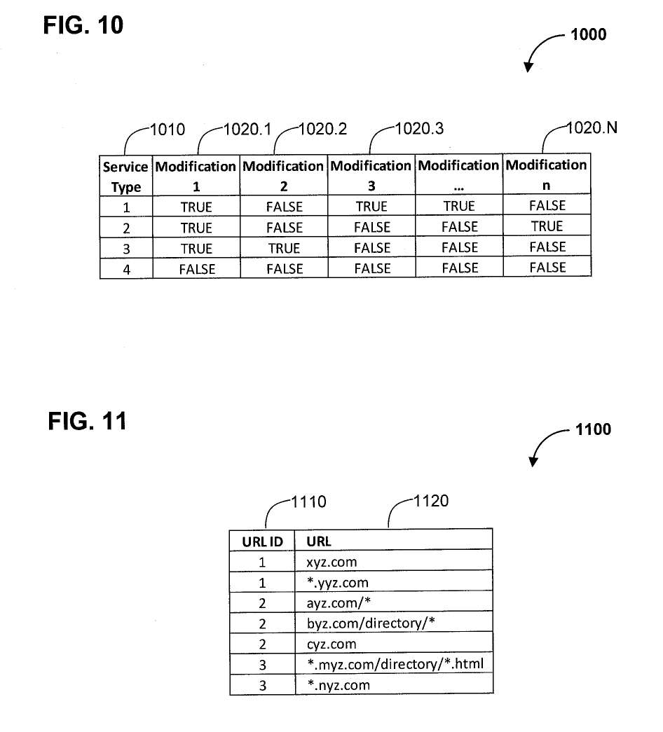

FIG. 10 depicts an exemplary service subscription database 1000 located at an ISP (or, alternatively, it can be located off-site on a separate network) (which can be any one of the ISPs 120.1-120.2) for storing service type modification information, in accordance with the present invention.

The service subscription database 1000 (which runs on a computer system as shown in FIG. 1 has at least two fields: 1) a Service Type field, 1010, containing the service type ID; and at least one 2) a Modification field, 1020, containing a logical value indicating whether or not the modification is applicable to the current service type.

FIG. 11 depicts an exemplary URL List database 1100 located at an ISP (or, alternatively, it can be located off-site on a separate network) (which can be any one of the ISPs 120.1-120.2) for storing URL restriction and inclusion information, in accordance with the present invention.

The URL list database 1100 (which runs on a computer system as shown in FIG. 1 has at least two fields: 1) a URL ID field, 1110, containing the URL ID number; and 2) a URL field, 1120, containing a specific URL.

FIG. 12 depicts an exemplary modification database 1200 located at an ISP (or, alternatively, it can be located off-site on a separate network) (which can be any one of the ISPs 120.1-120.2) for storing content modification information, in accordance with the present invention.

The modification database 1200 (which runs on a computer system as shown in FIG. 1 has at least six fields: 1) a Modification ID field, 1210, containing the modification ID number; 2) a URL Inclusion List field, 1220, which references URL IDs in the URL List database 1100 for which content modifications can be expressly made; 3) a URL Exclusion List field, 1230, which references URL IDs in the URL List database 1100 for which content modifications cannot be made; 4) a Minimum Time Since Last Modification field, 1240, which provides minimum time intervals in seconds which must have elapsed before another content modification can be made; 5) a Value field, 1250, which ranks modifications according to monetary and utility value; and 6) a URL of Modification Script field, 1260, which contains the network location of the modification script.

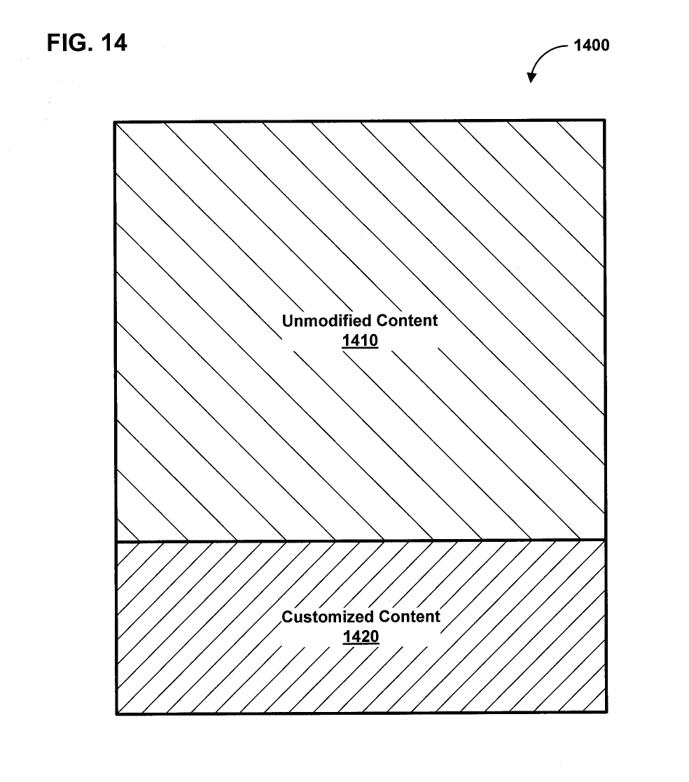

FIG. 13 depicts an exemplary web page or portion thereof 1300 after the content modification routine (700) has completed. The original content requested in step 605 (FIG. 6) is represented in frame 1310. The customized content which is returned in step 250 (FIG. 2) is displayed in frame 1320. In this embodiment of the content modification the customized content is displayed in a new frame at the top of the originally requested page.

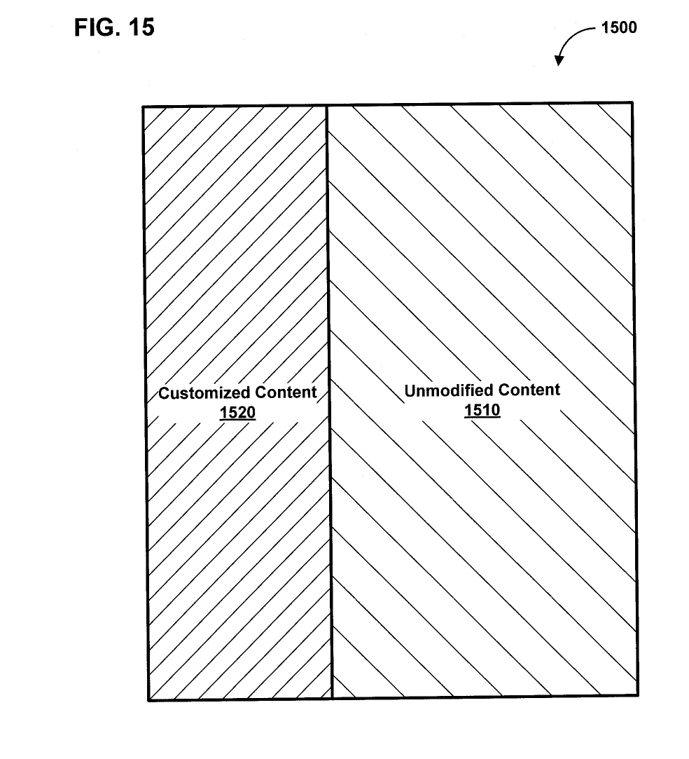

FIG. 14 depicts an exemplary web page or portion thereof 1400 after the content modification routine (700) has completed. The original content requested in step 605 (FIG. 6) is represented in frame 1410. The customized content which is returned in step 250 (FIG. 2) is displayed in frame 1420. In this embodiment of the content modification the customized content is displayed in a new frame at the bottom of the originally requested page.

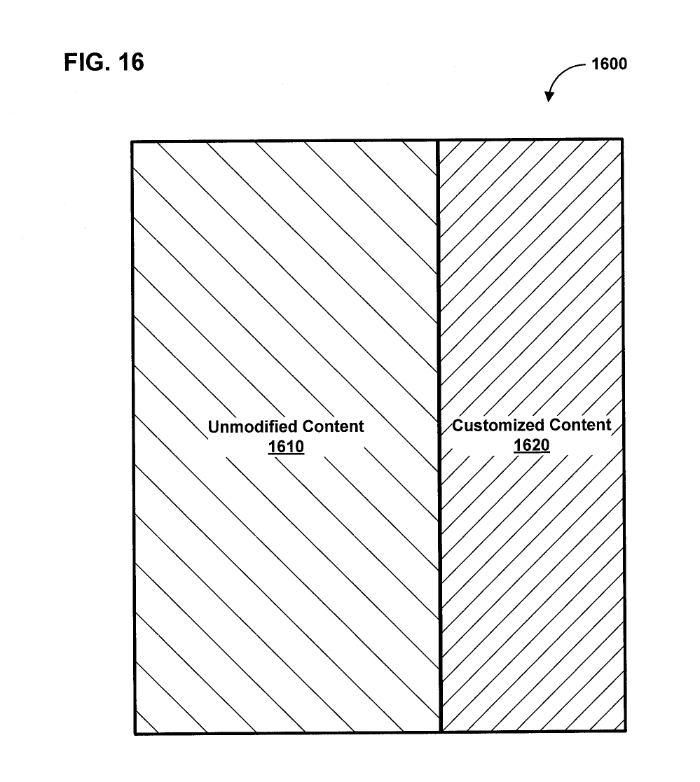

FIG. 15 depicts an exemplary web page or portion thereof 1500 after the content modification routine (700) has completed. The original content requested in step 605 (FIG. 6) is represented in frame 1510. The customized content which is returned in step 250 (FIG. 2) is displayed in frame 1520. In this embodiment of the content modification the customized content is displayed in a new frame at the left side of the originally requested page.

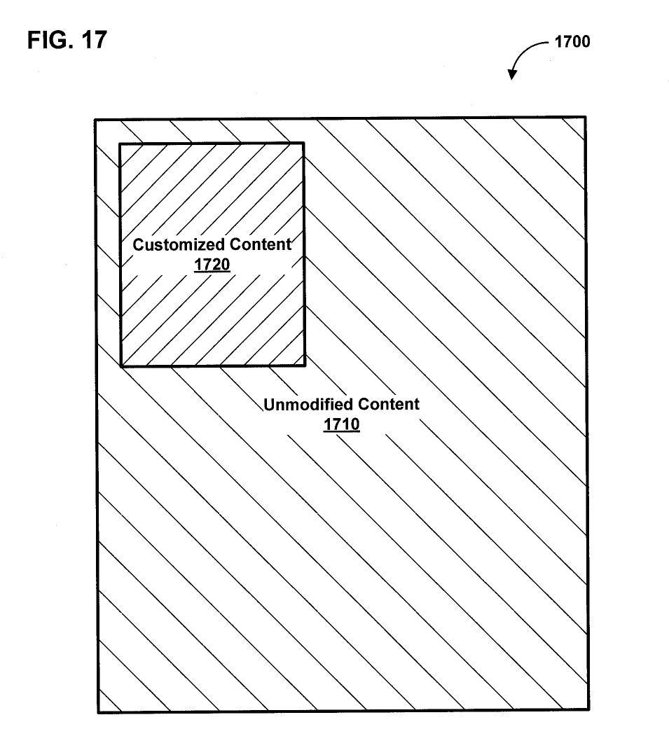

FIG. 16 depicts an exemplary web page or portion thereof 1600 after the content modification routine (700) has completed. The original content requested in step 605 (FIG. 6) is represented in frame 1610. The customized content which is returned in step 250 (FIG. 2) is displayed in frame 1620. In this embodiment of the content modification the customized content is displayed in a new frame at the right side of the originally requested page.

FIG. 17 depicts an exemplary web page or portion thereof 1700 after the content modification routine (700) has completed. The original content requested in step 605 (FIG. 6) is represented in frame 1710. The customized content which is returned in step 250 (FIG. 2) is displayed in the new window 1720. In this embodiment of the content modification the customized content is displayed in a new window in the form of a pop-up which is displayed over the original content window.

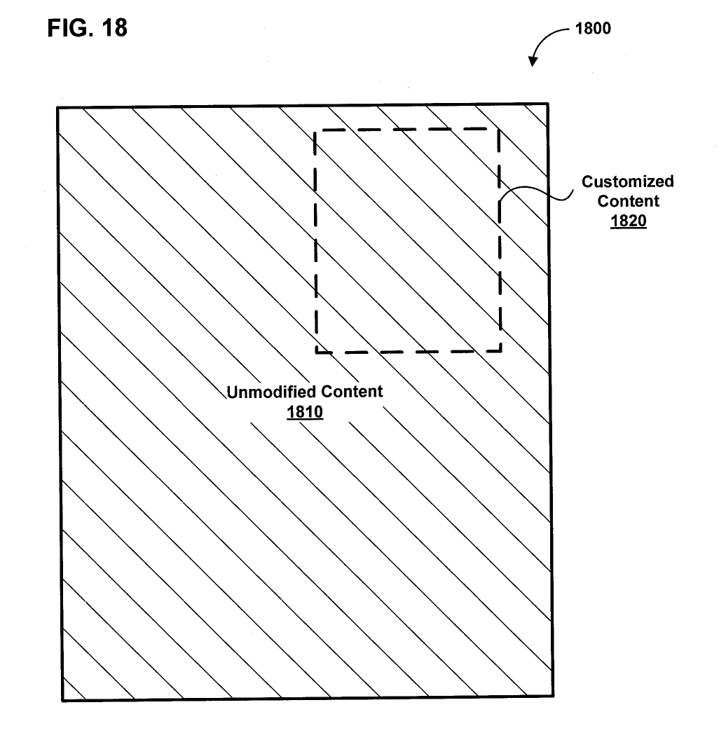

FIG. 18 depicts an exemplary web page or portion thereof 1800 after the content modification routine (700) has completed. The original content requested in step 605 (FIG. 6) is represented in frame 1810. The customized content which is returned in step 250 (FIG. 2) is displayed in the new window 1820. In this embodiment of the content modification the customized content is displayed in a new window in the form of a pop-under which is displayed underneath the original content window.

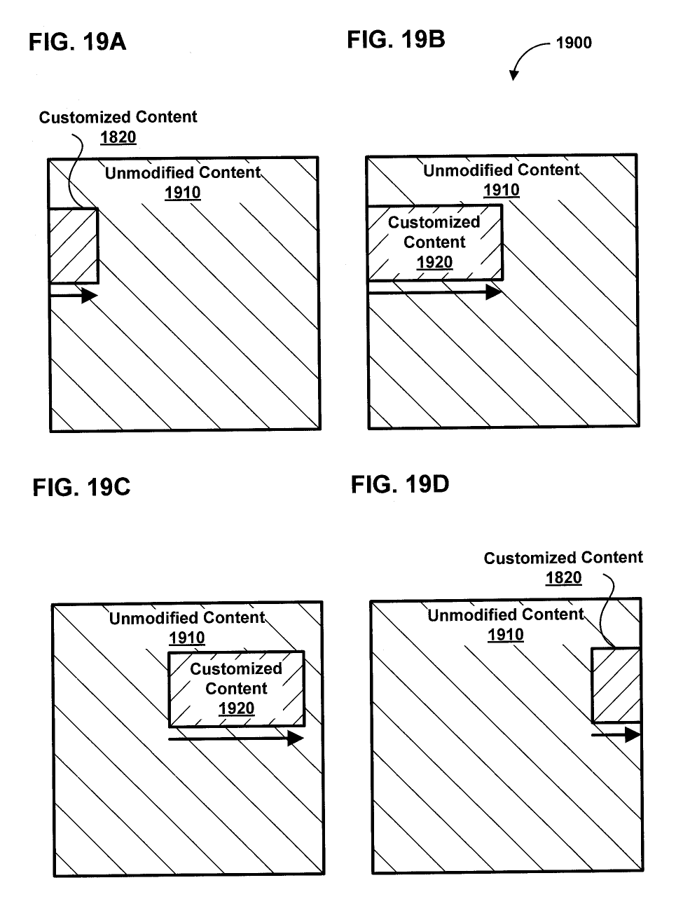

FIG. 19 depicts an exemplary web page or portion thereof 1900 after the content modification routine (700) has completed. The original content requested in step 605 (FIG. 6) is represented in content region 1910. The customized content which is returned in step 250 (FIG. 2) is displayed in the new content region 1820. In this embodiment of the content modification the customized content is displayed in a new content region which enters the window in FIG. 19A, flies over the originally requested content in FIG. 19B and FIG. 19C, and exits the window in FIG. 19D along a predetermined path.

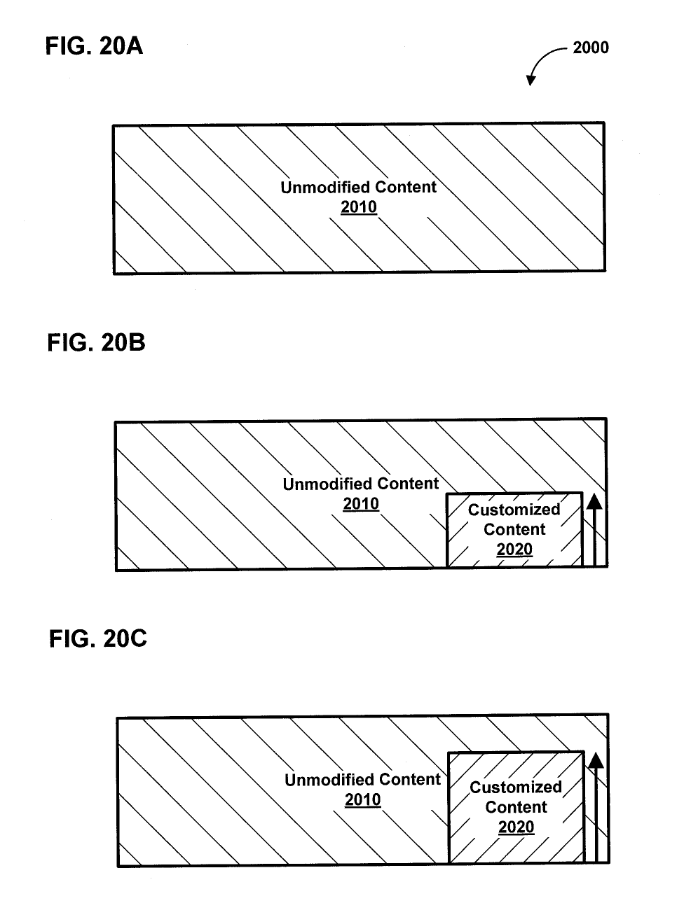

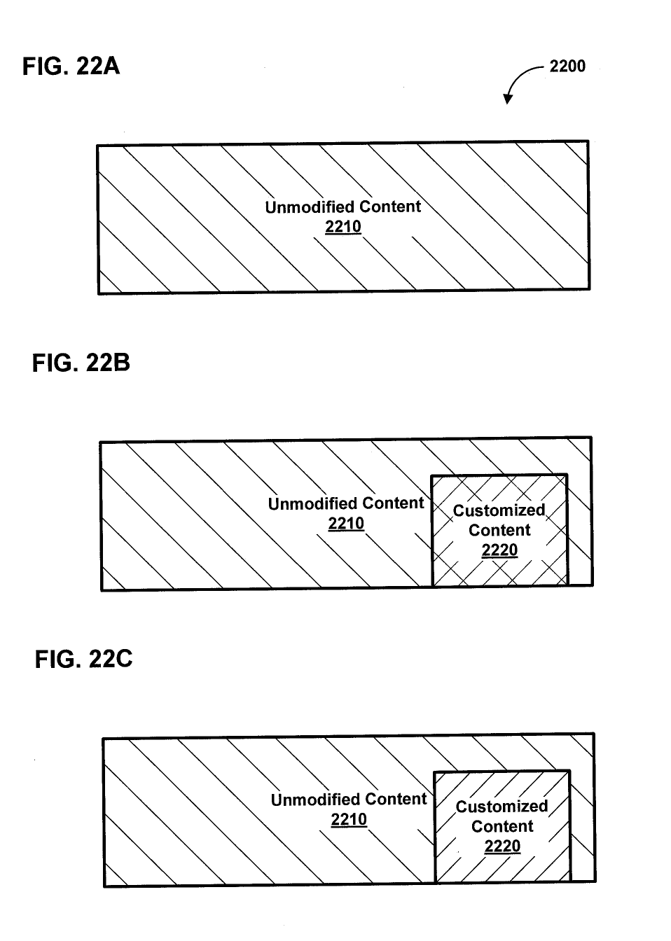

FIG. 20A depicts an exemplary web page or portion thereof 2000 after the content modification routine (700) has completed. The original content requested in step 605 (FIG. 6) is represented in frame 2010. In FIG. 20B the customized content which is returned in step 250 (FIG. 2) is displayed in the new content region 2020. In FIG. 22C the customized content in content region 2020 scrolls over the originally requested content to a final position as seen in FIG. 20C. In this embodiment of the content modification the customized content is displayed in a new content region which enters the window in FIG. 20B, and scrolls in over the originally requested content to a predetermined position as seen in FIG. 20C. The scrolling animation depicted in FIG. 20B and FIG. 20C can be configured to originate from multiple positions at different speeds and along multiple paths. In addition, the content region may be configured with additional behaviors which are characteristic of existing capabilities of web content.

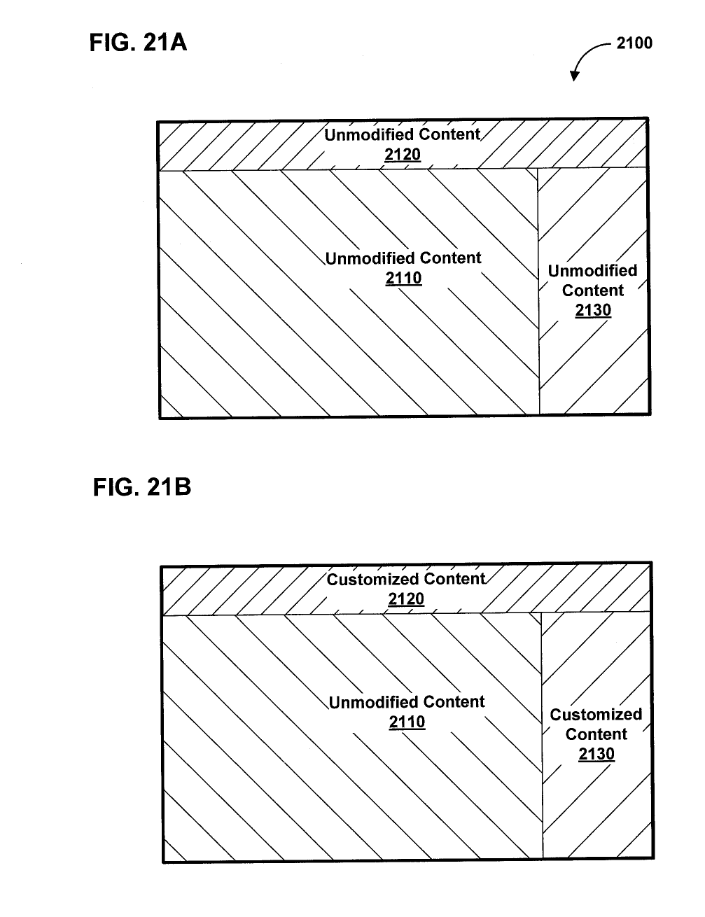

FIG. 21A depicts an exemplary web page or portion thereof 2100 before the content modification routine (700) has completed. The original content requested in step 605 (FIG. 6) is represented in FIG. 21A in frames 2110, 2120, and 2130. FIG. 21B depicts the exemplary web page 2100 after the content modification routine (700) has completed. The customized content which is returned in step 250 (FIG. 2) is displayed in the frames 2120 and 2130, while the original content in frame 2110 remains unmodified.

FIG. 22A depicts an exemplary web page or portion thereof 2200 after the content modification routine (700) has completed. The original content requested in step 605 (FIG. 6) is represented in frame 2210. In FIG. 22B the customized content which is returned in step 250 (FIG. 2) is displayed in the new, semi-transparent content region 2220. In FIG. 22C the customized content in frame 2220 is fully opaque. In this embodiment of the content modification the customized content is displayed in a new content region which enters the window in FIG. 22B, and fades in over the originally requested content at a predetermined position as seen in FIG. 22C. The fading animation depicted in FIG. 22B and FIG. 22C can be configured to occur at multiple positions and speeds. In addition, the content region may be configured with additional behaviors which are characteristic of existing capabilities of web content.

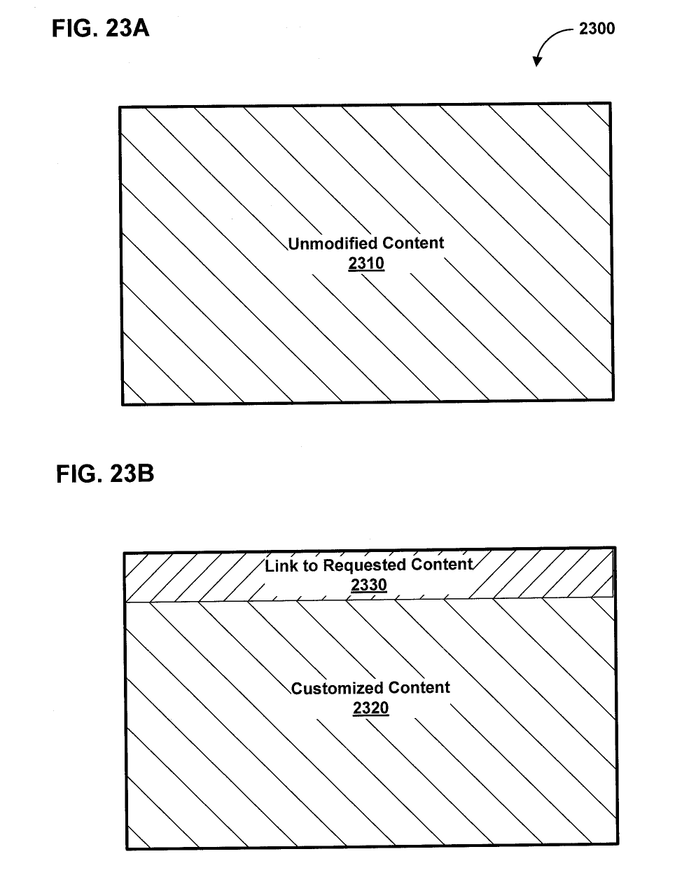

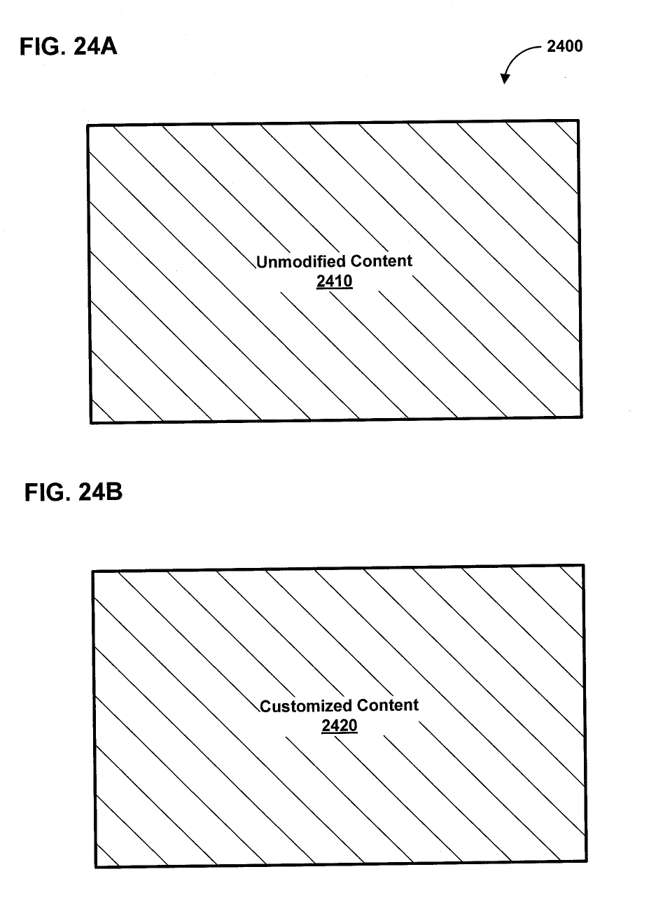

FIG. 23A depicts an exemplary web page or portion thereof 2300 which contains unmodified web content in 2310. FIG. 23B depicts an exemplary web page or portion thereof after the content modification routine (700) has completed. The customized content which is returned in step 250 (FIG. 2) is displayed in frame 2320. A hyperlink to original content requested in step 605 (FIG. 6) is represented in frame 2330. In this embodiment of the content modification the customized content is displayed in the form of an interstitial web page such that the customized content is displayed in a full page format before the originally requested content is delivered to the user. In addition, the frame may be configured with additional behaviors which are characteristic of existing capabilities of web content.

FIG. 24A depicts an exemplary web page or portion thereof 2400 which contains unmodified web content in 2410. FIG. 24B depicts an exemplary web page or portion thereof after the content modification routine (700) has completed. The customized content which is returned in step 250 (FIG. 2) is displayed in frame 2420. In this embodiment of the content modification the customized content is displayed in the form of an redirected web page such that the customized content is displayed in a full page format; when the original content requested in step 605 (FIG. 6) arrives, it is ignored by the client.

What is claimed is:

1. A method for directing network service provider selected embedded objects to an internet user client, comprising:
a network service provider maintaining a database of internet user clients that includes a particular service-type value for each internet user client;
the network service provider analyzing an HTTP transaction involving the internet user client;
the network service provider responding to an HTTP transaction requesting an embedded web object by forwarding to the internet user client, an alternative embedded web object selected in accordance with the user client's particular service-type value, wherein the alternative embedded web object arrives to the internet user client before a response to the originally requested embedded web object; and
the network service provider causing the originally requested embedded web object to be forwarded to the internet user client after the alternative embedded web object is forwarded to the internet user client.

2. A method for directing embedded objects as defined in claim 1, wherein the internet user client is a subscribing user client.

3. A method for directing embedded objects as defined in claim 1, wherein the network service provider is an internet service provider.

4. A method for directing embedded objects as defined in claim 1, wherein the alternative embedded web object includes a request for the originally requested embedded web object.

5. A method for directing embedded objects as defined in claim 1, wherein the originally requested embedded web object is a javascript object.

6. A method for directing embedded objects as defined in claim 1, wherein the alternative embedded web object is a javascript object that includes a request for a javascript object of the originally requested embedded web object.

7. A method for directing embedded objects as defined in claim 1, wherein the alternative embedded web object is selected by the network service provider.

8. A method for directing embedded objects as defined in claim 1, wherein the alternative embedded web object comprises a reference to the originally requested embedded web object, and a reference to an additional embedded web object.

9. A method for directing embedded objects as defined in claim 8, wherein the reference to an additional embedded web object is associated with targeted advertising web content.

10. A method for directing embedded objects as defined in claim 9, wherein the targeted advertising web content is selected by an advertisement selection service.

11. A method for directing embedded objects as defined in claim 10, wherein the advertisement selection service selects the targeted advertising web content based on at least one targeting parameter received from the network service provider.

12. A method for directing embedded objects as defined in claim 10, wherein the advertisement selection service selects the targeted advertising web content based on a modification value rank.

13. A method for directing embedded objects as defined in claim 8, wherein the reference to an additional embedded web object is selected in accordance with a URL inclusion field.

14. A method for directing embedded objects as defined in claim 8, wherein the reference to an additional embedded web object is selected in accordance with a URL restriction field.

15. A method for directing embedded objects as defined in claim 8, wherein customized content associated with the additional embedded web object is presented in a first frame, and unmodified content associated with the originally requested embedded web object is presented in a second frame.

16. A method for directing embedded objects as defined in claim 8, wherein a link to customized content associated with the additional embedded web object is presented in a first frame, and unmodified content associated with the originally requested embedded web object is presented in a second frame.

17. A method for directing embedded objects as defined in claim 8, wherein customized content associated with the additional embedded web object is presented in a new window displayed over a window presenting unmodified content associated with the originally requested embedded web object.

18. A method for directing embedded objects as defined in claim 8, wherein customized content associated with the additional embedded web object is presented in a new window under a window presenting unmodified content associated with the originally requested embedded web object.

19. A method for directing embedded objects as defined in claim 8, wherein customized content associated with the additional embedded web object is presented in a content region that flies over unmodified content associated with the originally requested embedded web object.

20. A method for directing embedded objects as defined in claim 8, wherein customized content associated with the additional embedded web object is presented in a semi-transparent content region over unmodified content associated with the originally requested embedded web object.

21. A method for directing embedded objects as defined in claim 20, wherein the semi-transparent content region fades into a fully opaque content region.

22. A method for directing embedded objects as defined in claim 1, wherein more than one internet user client is associated with a particular service-type value.

23. An apparatus for directing network service provider selected embedded objects to an internet user client, comprising:
means for maintaining a database of internet user clients that includes a particular service-type value for each internet user client;
means for analyzing an HTTP transaction involving the internet user client;
means for responding to an HTTP transaction requesting an embedded web object by forwarding to the internet user client, an alternative embedded web object selected in accordance with the user client's particular service-type value, wherein the alternative embedded web object arrives to the internet user client before a response to the originally requested embedded web object; and
means for causing the originally requested embedded web object to be forwarded to the internet user client after the alternative embedded web object is forwarded to the internet user client.

24. An apparatus for directing embedded objects as defined in claim 23, wherein the internet user client is a subscribing user client.

25. An apparatus for directing embedded objects as defined in claim 23, wherein the network service provider is an internet service provider.

26. An apparatus for directing embedded objects as defined in claim 23, wherein the alternative embedded web object includes a request for the originally requested embedded web object.

27. An apparatus for directing embedded objects as defined in claim 23, wherein the originally requested embedded web object is a javascript object.

28. An apparatus for directing embedded objects as defined in claim 23, wherein the alternative embedded web object is a javascript object that includes a request for a javascript object of the originally requested embedded web object.

29. An apparatus for directing embedded objects as defined in claim 23, wherein the alternative embedded web object comprises a reference to the originally requested embedded web object, and a reference to an additional embedded web object.

30. An apparatus for directing embedded objects as defined in claim 29, wherein the reference to an additional embedded web object is associated with targeted advertising web content.

31. An apparatus for directing embedded objects as defined in claim 30, wherein the targeted advertising web content is selected based on a modification value rank.

32. An apparatus for directing embedded objects as defined in claim 23, wherein more than one internet user client is associated with a particular service-type value.

33. A computer program product, comprising:
computer readable medium storing:
code for causing a computer to maintain a database of a network service provider's internet user clients that includes a particular service-type value for each internet user client;
code for causing a computer to analyze an HTTP transaction involving the internet user client;
code for causing a computer to respond to an HTTP transaction requesting an embedded web object by forwarding to the internet user client, an alternative embedded web object selected in accordance with the user client's particular service-type value, wherein the alternative embedded web object arrives to the internet user client before a response to the originally requested embedded web object; and
code for causing a computer to forward the originally requested embedded web object to the internet user client after the alternative embedded web object is forwarded to the internet user client.

34. A computer program product as defined in claim 33, wherein the alternative embedded web object includes a request for the originally requested embedded web object.

35. A computer program product as defined in claim 33, wherein the originally requested embedded web object is a javascript object.

36. A computer program product as defined in claim 33, wherein the alternative embedded web object is a javascript object that includes a request for a javascript object of the originally requested embedded web object.

37. A computer program product as defined in claim 33, wherein the alternative embedded web object comprises a reference to the originally requested embedded web object, and a reference to an additional embedded web object.

38. A computer program product as defined in claim 37, wherein the reference to an additional embedded web object is associated with targeted advertising web content.

39. A computer program product as defined in claim 38, wherein the targeted advertising web content is selected based on a modification value rank.

40. A computer program product as defined in claim 33, wherein more than one internet user client is associated with a particular service-type value.
